(19) United States
(12) Patent Application Publication
(10) Pub. No.: US 2007/0205985 A1
(43) Pub. Date: Sep. 6, 2007

(54) Method of using optical mouse scanning assembly for facilitating motion capture

(76) Inventor: Michael Trzecieski, Hong Kong (HK)

Correspondence Address: Michael Trzecieski, Flat 1A, 1F Caineway Mansion, 130 Caine Rd., Mid Levels, omitted

(21) Appl. No.: 11/682,277

(22) Filed: Mar. 5, 2007

Related U.S. Application Data
(60) Provisional application No. 60/767,127, filed on Mar. 5, 2006.

(51) Int. Cl. G09G 5/08

(52) U.S. Cl. 345/166

(57) ABSTRACT

Motion capture is a field where sensors are disposed about an animate object and the motions of the object are recorded such that they can be represented as 3D graphics on a computer. Unfortunately, motion capture devices, such as motion capture suits that are currently available on the marker are very expensive. Optical mouse technology has been well established over the past few years. As such, a method and apparatus of using an optical mouse scanning assembly with an external lens is disclosed for facilitating motion capture.

This application claims priority from U.S. Provisional Application No. 60/767,127 Filed on Mar. 5, 2006.

### FIELD OF THE INVENTION

The field of the invention is in the field of optical mice and more specifically for using the optical mouse scanning assembly for facilitating motion capture.

### BACKGROUND OF THE INVENTION

Motion capture is a field where sensors are disposed about an animate object and the motions of the object are recorded such that they can be represented as 3D graphics on a computer. Unfortunately, motion capture devices, such as motion capture suits that are currently available on the marker are very expensive.

Optical mice have become much cheaper in price over the past years and provide relative displacement and velocity information when the optical mouse is moved from a first position to a second position for two axes that are at an angle to each other. Typically these rates are up to 100 mm per second. Additionally, the optical sensor is a matrix of CMOS sensors that are directly accessible for providing of an image. Furthermore, optical mouse camera assemblies are very cheap. Unfortunately, optical mice are only useable at a close distance, on the order of less than 10 mm, to an object, otherwise they stop to function in terms of providing relative displacement information. Unfortunately, they cannot be used at a distance of, for example, a meter from an object.

It is therefore an object of the present invention to use an optical mouse scanning assembly for use as part of a motion capture device for facilitating motion capture in at least one axis.

### SUMMARY OF THE INVENTION

In accordance with the invention there is provided a motion capture device comprising: a first optical mouse scanning assembly comprising a first optical mouse scanning assembly camera; a first lens disposed in an optical path of the first optical mouse scanning assembly camera for affecting a focal length thereof; and a first processor coupled with the first optical mouse scanning assembly for receiving of first data therefrom that is representative of relative position and velocity data in at least one axis when the motion capture device is moved from a first position to a second position and for generating first processed data.

In accordance with the invention there is provided a method of motion capture comprising: providing a motion capture device comprising a first optical mouse scanning assembly comprising a first optical mouse scanning assembly camera; providing a first lens disposed in an optical path of the first optical mouse scanning assembly camera for affecting a focal length thereof; disposing the motion capture device in a known location on an object; providing a first processor coupled with the first optical mouse scanning assembly; and, generating a first set of data when the motion capture device is moved from a first position to a second position.

### BRIEF DESCRIPTION OF THE DRAWINGS

Exemplary embodiments of the invention will now be described in conjunction with the following drawings, in which:

FIG. 1a illustrates a motion capture device in accordance with a first embodiment of the invention, where the motion capture device includes a first optical mouse scanning assembly;

FIG. 1b illustrates a motion capture device in accordance with a second embodiment of the invention having a first optical mouse scanning assembly and a second optical mouse scanning assembly;

FIG. 1c illustrates a motion capture device in accordance with a third embodiment of the invention and having a first optical mouse scanning assembly, a non optical sensor and a processor coupled therewith for receiving of data therefrom;

FIG. 1d illustrates a motion capture device in accordance with a fourth embodiment of the invention for being disposed on a person in a predetermined location on the body;

FIG. 1e illustrates a motion capture device in accordance with the embodiments of the invention for being disposed on a person in a predetermined location on the body;

FIG. 1f illustrates a motion capture assembly, in accordance with the first embodiment of the invention as shown in FIG. 1a, which is disposed at a distance from an object; and,

FIG. 1g illustrates a method of motion capture.

### DETAILED DESCRIPTION OF EMBODIMENTS OF THE INVENTION

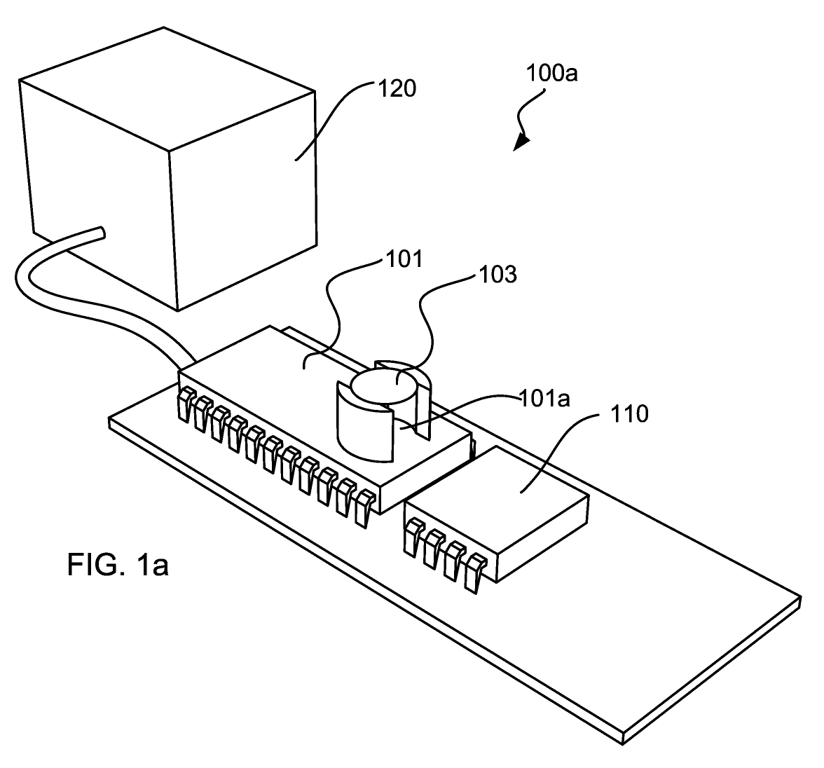

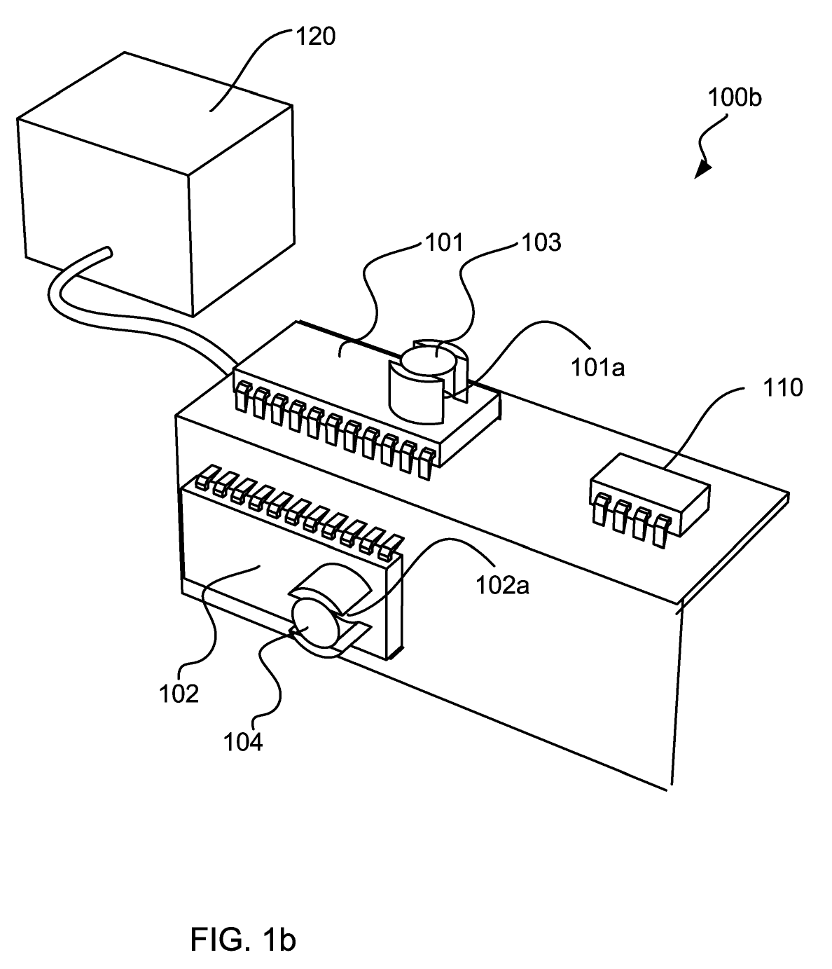

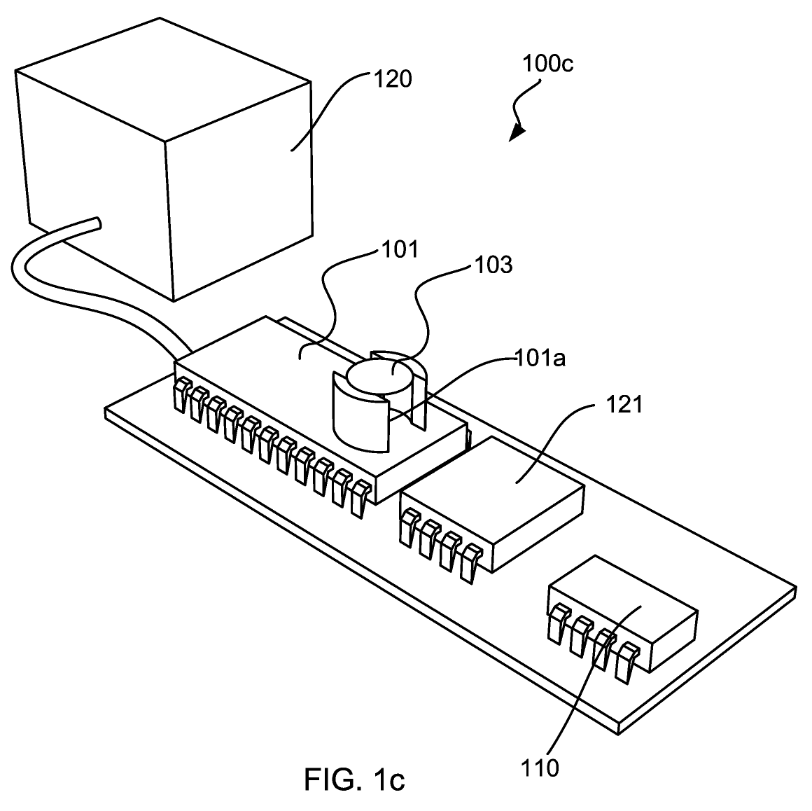

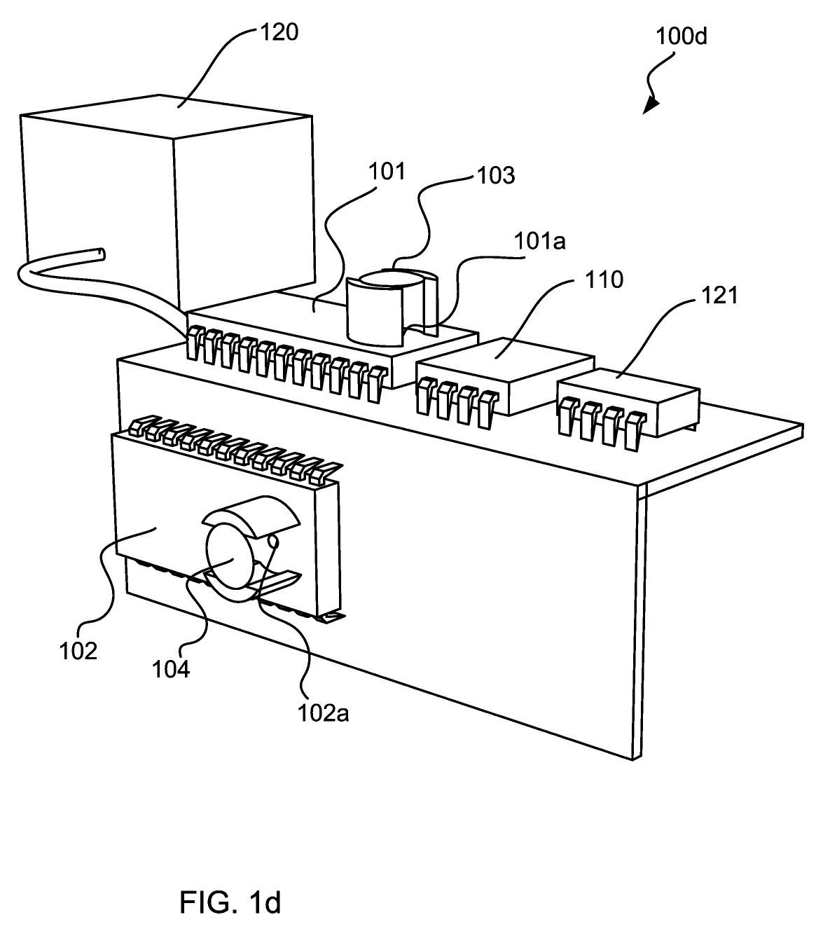

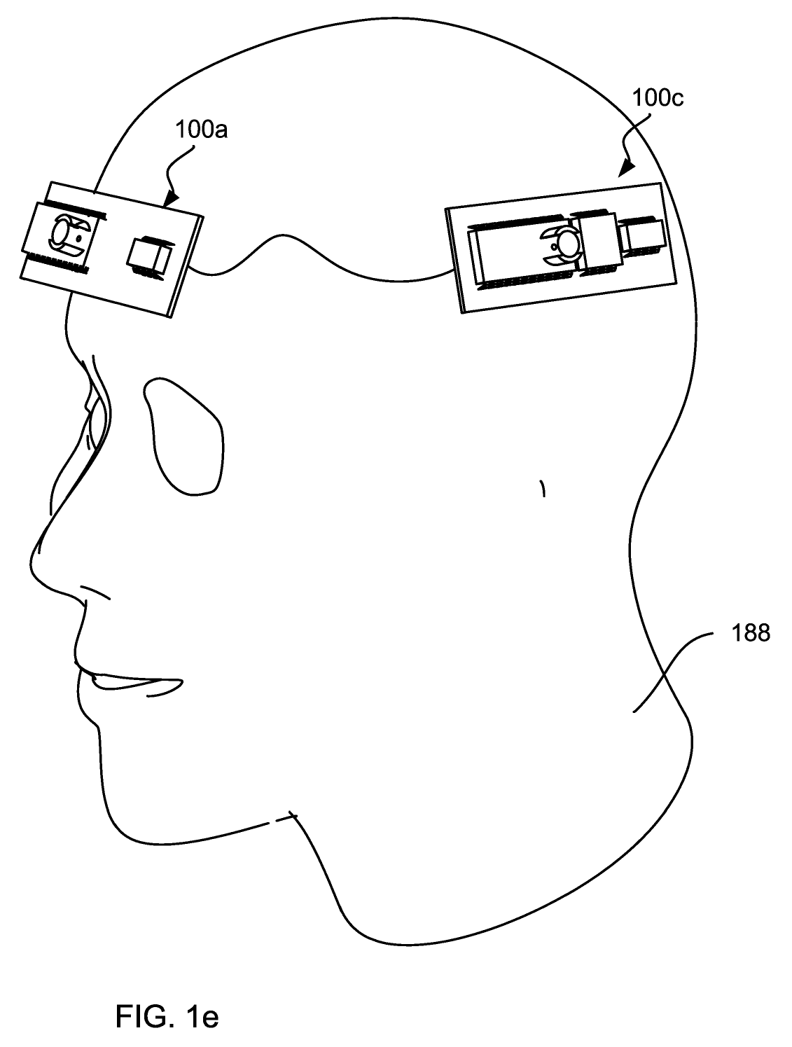

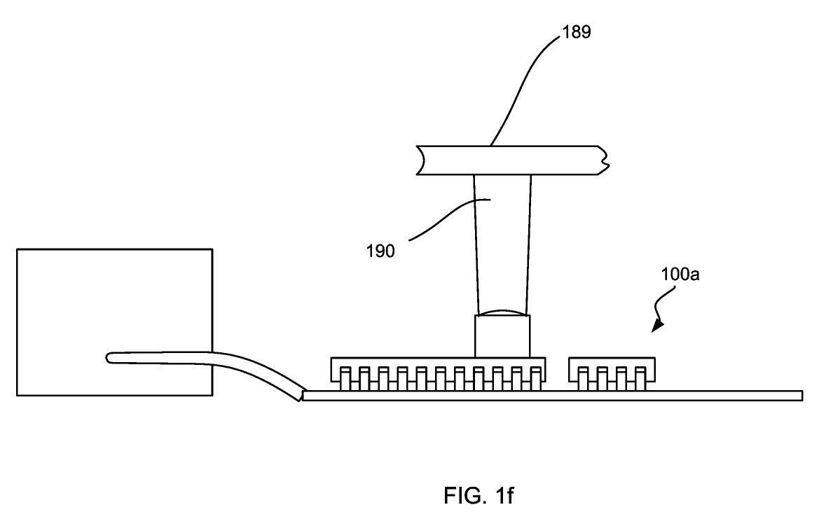

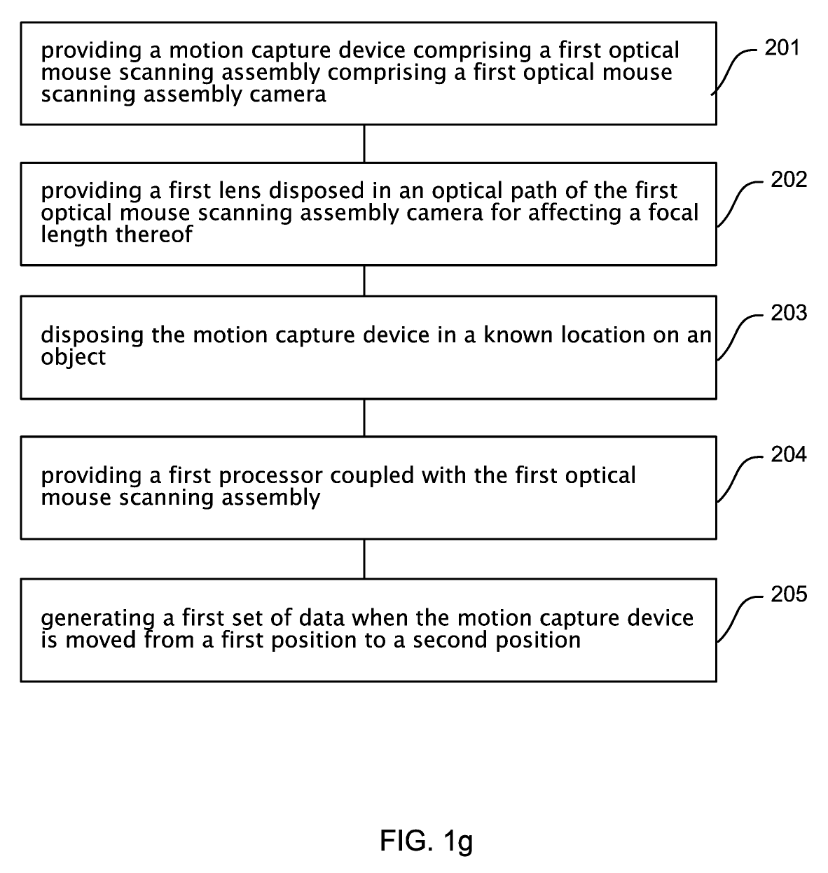

FIG. 1a illustrates a motion capture device 100a in accordance with a first embodiment of the invention. The motion capture device 100a is formed from a first optical mouse scanning assembly 101, a first camera 101a, a first lens 103 and a first processor 110 coupled with first optical mouse scanning assembly 101 for receiving of first data therefrom. A power supply 120 is coupled with the first optical mouse scanning assembly 101 and the first processor 110.

Through the use of the first lens 103, an image that is further away from the first optical mouse scanning assembly 101 is utilized as if the first optical mouse scanning assembly 101 is operating on a surface that is approximately 10 mm away from the first camera 101a, as is performed in prior art optical mice. The first lens 103 brings, distant objects that are further away than 10 mm, for example, walls of a room into focus of the first camera 101a and as such allows for objects that are, for example, at least a meter away to be used for relative position determination when the motion capture device 100a is moved from a first position to a second position.

In use, a first set of data is provided from the first optical mouse scanning assembly 101. From this first set of data, a relative movement determination is made in displacement of the motion capture device 100a from a first position to a second position. This first set of data typically includes velocity and relative displacement information from the first position to the second position. The first set of data includes relative displacement information in at least one axis when the motion capture device 100a is moved from the first position to the second position. Typically prior art optical mouse scanning assemblies provide relative displacement and velocity information in two orthogonal axes. The first processor 110 receives the first data and provides first processed data that is derived therefrom.

Referring to FIG. 1f, the motion capture device 100a in accordance with the first embodiment of the invention is disposed at a distance from an object 189 with the optical path indicated as 190. The first lens 103 disposed in the optical path 190 affects a focal length of the first camera 101a.

FIG. 1b illustrates a motion capture device 100b in accordance with a second embodiment of the invention having a first optical mouse scanning assembly 101 and a second optical mouse scanning assembly 102 disposed at an angle to with respect to each other and at a distance from each other.

Each optical mouse scanning assembly 101, 102 has a lens 103, 104 disposed in an optical path thereof for affecting a focal length of each camera 101a, 101b, respectively. The first and second optical mouse scanning assemblies 101, 102 are disposed at a distance therebetween and at an angle such that a respective field of views of these optical mouse camera assemblies 101, 102 preferably does not overlap for facilitating improved motion capture due to increased amounts of data being available from surrounding objects. The first processor 110 is coupled with each of the first and second optical mouse scanning assemblies, 101, 102, respectively.

Each first optical mouse scanning assembly 101 and second optical mouse scanning assembly 102 respectively provides first and second sets of data that are derived from changes in position from a first position to a second position of the motion capture device 100b in accordance with a second embodiment of the invention. The first processor 110 combines the first and second sets of data in order to make a determination of relative displacement from the first position to the second position of the motion capture device 100b in accordance with a second embodiment of the invention. The first processor 110 provides second processed data that is derived from the first and second sets of data.

For example, in disposing the motion capture device 100b in accordance with a second embodiment of the invention on a limb of an individual, movement of that limb is determinable in two axes, for example in the up/down and left/right directions.

FIG. 1c illustrates a motion capture device 100c in accordance with a third embodiment of the invention. The third embodiment of the invention 100c is formed from a first optical mouse scanning assembly 101, a first camera 101a, a first lens 103, a non optical sensor 121 and a first processor 110 coupled with first optical mouse scanning assembly 101 for receiving of first data therefrom and coupled with the non optical sensor 121 for receiving of non optical data therefrom.

In use, a first set of data is provided from the first optical mouse scanning assembly 101 and non optical data is provided from the non optical sensor 121 to the first processor 110. From the first data, relative movement determination is made in displacement of the motion capture device 100b from the first position to the second position. This first data typically includes velocity and relative displacement. The non optical data is preferably used to at least periodically recalibrate the first optical mouse scanning assembly 101 during use thereof. The first processor 110 provides third processed data that is derived from the first set of data and the non optical data.

FIG. 1d illustrates a motion capture device 100d in accordance with a fourth embodiment of the invention having a first optical mouse scanning assembly 101 and a second optical mouse scanning assembly 102 disposed at an angle to with respect to each other and at a distance from each other. The non optical sensor 121 is disposed proximate the second optical mouse scanning assembly 102 and coupled with the first processor 110. The first processor 110 is for receiving of non optical data from the non optical sensor 121 as well as the first data.

The non optical sensor 121 is preferably in the form of an accelerometer for providing of acceleration information in at least an axis for at least one of recalibrating and improving an accuracy of the first data derived from the first optical mouse scanning assembly 101. Further optionally, the non optical sensor 121 is in the form of a gyroscope and is disposed as part of the motion capture device 100d in accordance with the fourth embodiment of the invention. Of course, providing and accelerometer and a gyroscope may be preferable as the non optical sensor 121. Utilizing a magnetic compass as part of the non optical sensor 121 for providing of an absolute direction relative to the earth's magnetic field is also envisaged. Further optionally, the non optical sensor 121 is in the form of a ball switch for providing a reset signal to the processor at a predetermined position between the first position of the second position when the motion capture device 100d in accordance with the fourth embodiment of the invention is displaced therebetween. The first processor 110 provides fourth processed data that is derived from the first and second sets of data as well as the non optical data.

FIG. 1e illustrates a motion capture device in accordance with the embodiments of the invention for being disposed on a person in a predetermined location on the body 188. In this case, the motion capture device 100a in accordance with a first embodiment of the invention is disposed proximate a forehead of the body 188 and the motion capture device 100c in accordance with a third embodiment of the invention is disposed proximate a side of the head of the body 188. The two motion capture devices are preferably coupled together.

FIG. 1f illustrates a method of motion capture. In a first step 201 a motion capture device is provided comprising a first optical mouse scanning assembly comprising a first optical mouse scanning assembly camera. In a second step 202 a first lens disposed in an optical path of the first optical mouse scanning assembly camera for affecting a focal length thereof is provided. In a third step 203 the motion capture device is disposed in a known location on an object. In a fourth step 204 a first processor is provided and coupled with the first optical mouse scanning assembly. In a fifth step 205 a first set of data is generated when the motion capture device is moved from a first position to a second position.

Prior to performing of motion capture, preferably a representative 3D model of the person along with the predetermined positions of the motion capture devices in accordance to the various embodiments of the invention is generated with a computer, or other processor. Having known positions of the motion capture devices disposed about the body and having the representative 3D model facilitates accuracy in the motion capture. Preferably, such that the movement of the motion capture device is reflected in the movement of the skeletal model. Through calibration, preferably using a lookup table, a transformation is performed on the at least one of the first through fourth processed data for reflecting motion of the predetermined positions of the motion capture devices in relation to the representative 3D model.

For example at the first position the motion capture device a reset operation and during operation periodic resets may be required through drift of at least one of the first and second sets of data. Optionally, through the use of the non optical sensor 121, additional information such as acceleration and information relating to the earth's magnetic field is provided.

Upon calibrating the motion capture device the data provided therefrom is used for determining, for example, motion relative to surroundings of a limb of a person. Using pluralities of such devices, in accordance with the embodiments of the invention, disposed about the body in predetermined positions, facilitates motion capture of the various limbs of the person. Through combining sets of processed data from each of the processors that are formed as part of the embodiments of the invention and through calibration of each of the embodiments of the invention, motion capture of relative motions of body parts that have the motion capture devices coupled thereto is envisaged. This motion is then reflected in the 3D skeletal model.

Optionally the motion capture device is used for transmitting data to a robot, such that a transformation is performed between the skeletal data of the person and the limbs of the robot. Preferably this is calibrated in such a manner that the person's motions are accurately reflected in motions of a biped robot. For example when the person walks forward, the robot propagates in a forward direction. Similarly when the person moves their arms, the robot moves its arms. This is also applicable to the motion of other objects that are not animate, such as plants.

Further optionally the motion capture devices in accordance with embodiments of the invention are provided with a wireless transmitter and receiver in order to communicate wirelessly with each other and a base unit.

Optionally a light source is co-collimated with the optical path of the optical mouse scanning assembly in accordance with one of the embodiments of the invention for facilitating operation of the optical mouse scanning assembly in dim light conditions.

Numerous other embodiments are envisaged without departing from the spirit or scope of the invention.

What is claimed is:

1. A motion capture device comprising:
a first optical mouse scanning assembly comprising a first optical mouse scanning assembly camera;
a first lens disposed in an optical path of the first optical mouse scanning assembly camera for affecting a focal length thereof; and,
a first processor coupled with the first optical mouse scanning assembly for receiving of first data therefrom that is representative of relative position and velocity data in at least one axis when the motion capture device is moved from a first position to a second position and for generating first processed data.

2. A motion capture device according to claim 1 comprising:
a non optical sensor coupled with the first processor and disposed in proximity with the first optical mouse scanning assembly for generating non optical sensor data, where the first processor generates second processed data in dependence upon the first data and the non optical sensor data.

3. A motion capture device according to claim 2 wherein the non optical sensor comprises an accelerometer for generating acceleration data in at least an axis and for providing data related to this acceleration to the first processor as the non optical data.

4. A motion capture device according to claim 3 wherein the non optical sensor comprises a gyroscope disposed in proximity with the first optical mouse scanning assembly and for generating rotational data about at an axis for provision to the first processor in the form of the non optical data.

5. A motion capture device according to claim 2 wherein the non optical sensor comprises a magnetic compass disposed in proximity with the first optical mouse scanning assembly and for generating directional data relative to the earths magnetic field for provision to the first processor in the form of the non optical data.

6. A motion capture device according to claim 1 comprising: a light source co-collimated with the optical path of the first optical mouse scanning assembly for facilitating operation of the optical mouse scanning assembly in reduced light conditions.

7. A motion capture device according to claim 1 comprising:
a second optical mouse scanning assembly comprising a second optical mouse scanning assembly camera disposed at an angle and distance from the first optical mouse scanning assembly;
a second lens disposed in an optical path of the second optical mouse scanning assembly camera for affecting a focal length thereof; and,
the first processor coupled with the second optical mouse scanning assembly for receiving of second data therefrom that is representative of relative position and velocity data in at least one axis when the second motion capture device is moved from a third position to a fourth position for generating second processed data.

8. A motion capture device according to claim 1 wherein the first lens is at a distance of over 10 mm from an object when the motion capture device is moved from the first position to the second position relative to the object.

9. A motion capture device according to claim 1 comprising: a light source co-collimated with the optical path of the first optical mouse scanning assembly for facilitating operation of the optical mouse scanning assembly in reduced light conditions.

10. A method of motion capture comprising:
providing a motion capture device comprising a first optical mouse scanning assembly comprising a first optical mouse scanning assembly camera;
providing a first lens disposed in an optical path of the first optical mouse scanning assembly camera for affecting a focal length thereof;
disposing the motion capture device in a known location on an object;
providing a first processor coupled with the first optical mouse scanning assembly; and,
generating a first set of data when the motion capture device is moved from a first position to a second position.

11. A method of motion capture according to claim 10 comprising:
processing of the first set of data to generate first processed data.

12. A method of motion capture according to claim 10 comprising:
generating a skeletal model that is representative of the object and of the known location where the motion capture device is disposed on the object.

13. A method of motion capture according to claim 10 comprising: wirelessly transmitting the first processed data.
